(19) United States
(12) Patent Application Publication
(10) Pub. No.: US 2003/0108283 A1
(43) Pub. Date: Jun. 12, 2003

(54) Optical demultiplexer module

(76) Inventors: Toshihiko Ota, Tokyo (JP); Haruki Ogoshi, Tokyo (JP); Tsunetoshi Saito, Tokyo (JP); Toshiaki Tsuda, Tokyo (JP)

Correspondence Address: Clifford H. Kraft, 320 Robin Hill Drive, Naperville, IL, 60540, US

(21) Appl. No.: 10/147,267

(22) Filed: May 14, 2002

Related U.S. Application Data
(63) Continuation-in-part of application No. 09/516,939, filed on Mar. 1, 2000, now abandoned.

(30) Foreign Application Priority Data
Mar. 5, 1999 (JP) 11-059348
Mar. 12, 1999 (JP) 11-066834
Nov. 25, 1999 (JP) 11-334415

(51) Int. Cl. G02B 6/293; G02B 6/34; G02B 6/26

(52) U.S. Cl. 385/24; 385/37; 385/15

(57) ABSTRACT

The present invention provides an optical demultiplexer module capable of narrowing the interval between wavelengths of divided light. The optical demultiplexer module is provided with an optical circulator (2) or a non-reciprocal optical branching device, the first and second optical waveguides (3) and (4) connected to the optical circulator or non-reciprocal optical branching device, and the second arrayed waveguide diffraction grating (6) connected to the second optical waveguide (4) and having a plurality of emitting ports (6a) through (6h). The first optical waveguide (3) has a plurality of filters (3a) through (3i) which reflects light of a specified wavelength to the second optical waveguide (4) via the optical circulator (2) or non-reciprocal optical branching device. In the second arrayed waveguide diffraction grating (6), the center wavelengths of light emitted from a plurality of emitting ports differ by an appointed frequency in terms of frequency.

This application is a continuation-in-part of U.S. patent application Ser. No. 09/516,939 filed Mar. 1, 2000.

### FIELD OF THE INVENTION

The present invention relates to an optical demultiplexer module used in an optical wavelength-multiplexed transmission, etc.

### BACKGROUND OF THE INVENTION

In recent years, studies and research have been actively executed with respect to optical frequency-multiplexed transmissions as a means for remarkably increasing transmission capacity. An optical wavelength-multiplexed transmission is to transmit a plurality of light having different wavelengths by multiplexing. In such an optical wavelength-multiplexed transmission system, an optical dividing device (wavelength synthesizing and dividing device) is indispensable, which is capable of picking up a plurality of transmitted light by wavelengths or multiplexing light of different wavelengths.

Also, in order to increase the bit rate in the wavelength-multiplexed transmissions, it is considered that the number of wavelengths to be multiplexed is increased, or the bit rate of the respective wavelengths is made faster, wherein the optical dividing devices are required to have characteristics corresponding to multi-channels and high bit rate transmissions.

In order to increase the number of wavelengths, it is necessary to narrow the interval between wavelengths of light to be multiplexed, and recently, an optical dividing device (wavelength synthesizing and dividing device) having a very narrow interval like 0.4 nm between wavelengths has been required. Further, to correspond to a high bit rate, it is also required that the insertion loss in a wavelength transmission band is uniform, that is, flat transmission characteristics is required. It is necessary to provide an optical demultiplexer module which is capable of dividing light of as a narrow wavelength interval as possible, in order to increase the transmission capacity. As such a dividing device, an arrayed waveguide diffraction grating, an optical fiber grating, or that in which a dielectric multi-layered film is used has been publicly known. In particular, for optical frequency multiplexed transmission, an arrayed waveguide diffraction grating disclosed in, for example, Japanese Laid-Open Patent Publication No. 49936 of 1997 has been noted as an optical dividing device.

As this type of an arrayed waveguide diffraction grating that illustrated in FIG. 1 has been publicly known. An arrayed waveguide diffraction grating 60 is such that a waveguide pattern is formed on a substrate 61. In the waveguide pattern, an incident side slab waveguide 63, which acts as the first slab waveguide is connected to the emitting side of one or more incident waveguides 62 formed in parallel. A plurality of arrayed waveguides 64 formed in parallel are connected to the emitting side of the incident waveguide 63, and an emitting side slab waveguide 65 which acts as the second slab waveguide is connected to the emitting side of the plurality of arrayed waveguides 64. Further, a plurality of optical emitting waveguides 66 formed in parallel are connected to the emitting side of the emitting side slab waveguide 65.

When wavelength-multiplexed light enters the incident waveguide 62 of the arrayed waveguide diffraction grating 60, light having different wavelengths per emitting port as the center wavelength is emitted from the emitting side thereof, whereby the arrayed waveguide diffraction grating 60 can function as an optical dividing device.

FIG. 2 shows wavelength characteristics of one optional emitting port of the arrayed waveguide diffraction grating in FIG. 1, wherein the transmission characteristic shows a wavelength characteristic by which the transmittance is maximized at a certain center wavelength. Usually, although the center wavelength is set so that it is made coincident with the wavelength of optical transmission, it is necessary to permit a bandwidth of some degree since it is unavoidable that the transmitting wavelength of a light source for transmission fluctuates. The bandwidth is usually expressed in terms of flatness around the center wavelength, and it becomes a factor to determine the limit of a bit rate.

That is, in a high bit rate transmission, satisfactory flatness is required. Usually, the flatness is expressed in terms of 1 dB-down bandwidth of transmittance. For example, in an arrayed waveguide diffraction grating whose channel interval is 1000 GHz (approx. 0.8 nm), the 1 dB-down bandwidth is approximately 0.35 nm.

Since the production cost is barely adversely influenced even though the number of emitting ports is increased in the arrayed waveguide diffraction grating 60, the arrayed waveguide diffraction grating is thought highly of as a device, which takes a role of a wavelength synthesizing and dividing device in wavelength-multiplexed transmissions from now on.

However, alternative options have been proposed. For example, in U.S. Pat. No. 5,748,350 Pan et al. describes a demultiplexer including an optical circulator and serially arranged Bragg gratings. This prior art device takes advantage of the excellent wavelength response of the Bragg gratings and combines this response with a conventional coarse demultiplexer. Pan suggests that the prior art device will work with optical filters or arrayed waveguide gratings as coarse demultiplexers. While Pan presents an interesting device it does not provide one with good commercial application. This prior art device is likely to have good wavelength characteristics however it will attenuate different optical signals by different amounts in dependence upon wavelength. This is very problematic because in most applications it is necessary to ensure that the optical signals are held within a predetermined range of intensity. This intensity range is necessary to ensure that the signal to noise ratio is adequate. When the signal to noise ratio is poor, the detectors that receive the optical signals will provide signals that do not accurately represent the optical data provided to the optical network.

Having said that a system incorporating the demultiplexer according to Pan will work with the addition of a variety of costly components. These components are necessary to flatten the wavelength response of the demultiplexer and amplify this flattened response. These components are commonly known as “gain flattening filters” and “optical amplifiers”. The gain flattening filter is chosen to provide a wavelength response opposite to that of the optical amplifier in combination with the demultiplexer according to Pan. Procuring this gain flattening filter is likely to be difficult since the wavelength response of the demultiplexer according to Pan is highly not smooth. Additionally, optical amplifiers, such as erbium doped fiber amplifiers are very expensive and often have long lead times. It should be noted that the demultiplexer according to Pan will not require an erbium doped fiber amplifier however it will attenuate optical signals substantially and thereby increase the need and likely the quantity of any large networks that incorporate this type of demultiplexer.

### OBJECT AND SUMMARY OF THE INVENTION

Generally speaking, one of the important characteristics of an arrayed waveguide diffraction grating (wavelength synthesizing and dividing device) is crosstalk between channels. The crosstalk is expressed in view of relative intensity of light leaking from one port to the other port when light passes through the former port. When viewed at one port, the crosstalk is expressed in terms of the ratio of the intensity of transmitted light at the center wavelength to the intensity of light leaking from the other port.

FIG. 3 explains the crosstalk. With respect to a port having the wavelength characteristic depicted by a solid line, the wavelength characteristic depicted by a dashed line indicates the wavelength characteristics of ports of ±1 channels. FIG. 3 shows the relationship between the wavelength characteristics depicted by the solid line and the cross talk of ±1 channels.

In line with an increase in the transmission volume, in wavelength-multiplexed transmissions, the interval between channels is inclined to be made narrower and narrower, wherein an arrayed waveguide diffraction grating (wavelength synthesizing and dividing device) having a narrow interval between wavelengths is required. At present, arrayed waveguide diffraction gratings whose interval between channels is 100 GHz have been realized. From now, arrayed waveguide diffraction gratings whose interval is 50 GHz will be required.

However, in order to narrow the interval between channels in the arrayed waveguide diffraction grating 60, such problems arise, in that the flatness worsens, and the crosstalk of adjacent channels worsens. In the arrayed waveguide diffraction grating which divides the wavelength of light, for example, as shown in FIG. 4A and FIG. 4B, a plurality of divided light overlap each other at both sides of the center wavelength in the shape of a Gaussian distribution, and it was difficult to make the interval between channels of the respective divided light narrow. Therefore, in an optical demultiplexer module for optical frequency-multiplexed transmissions in which an arrayed waveguide diffraction grating is used, another problem occurs, by which it is not possible to sufficiently prevent the crosstalk between adjacent ports.

The present invention was developed in view of the above description. It is therefore an object of the invention to provide an optical demultiplexer module, which is capable of narrowing the interval of wavelengths of divided light. Further, it is another object of the invention to provide an optical demultiplexer module which is capable of making almost uniform the light intensity of respective divided light and is excellent in the optical dividing quality.

In order to achieve the abovementioned objects, an optical demultiplexer module according to the invention comprises an optical circulator or a non-reciprocal optical branching device, first and second optical waveguides connected to the corresponding optical circulator or non-reciprocal optical branching device, and a second arrayed waveguide diffraction grating connected to the corresponding second optical waveguide and having a plurality of emitting ports, wherein the corresponding first optical waveguide has a plurality of filters for reflecting light of a specified wavelengths to the corresponding second optical Waveguide via the corresponding optical circulator or non-reciprocal optical branching device, and the corresponding second arrayed waveguide diffraction grating is constructed so that the center wavelengths of light emitted from the corresponding plurality of emitting ports differ from each other by a certain predetermined frequency in terms of frequency.

Preferably, the corresponding second arrayed waveguide diffraction grating is constructed so that the center wavelength of light reflected from the corresponding plurality of filters matches one to one the center wavelength of light emitted from the corresponding plurality of emitting ports at at least one port.

Also, preferably, the corresponding second arrayed waveguide diffraction grating is constructed so that the center wavelengths of light emitted from the corresponding plurality of emitting ports uniformly differ from each other by a fixed frequency (nHz) in terms of frequency.

Still preferably, the first arrayed waveguide diffraction grating, having a plurality of emitting ports, in which the center wavelengths of light emitted from the corresponding plurality of emitting ports differ from each other by a certain frequency predetermined in terms of frequency is connected to the corresponding first optical waveguide.

Preferably, the corresponding first arrayed waveguide diffraction grating is constructed so that the center wavelengths of light transmitting through a plurality of filters which the corresponding first optical waveguide has, match one to one the center wavelength of light emitted from the corresponding plurality of emitting ports at least one port.

In addition, preferably, the corresponding first arrayed waveguide diffraction grating is constructed so that the center wavelengths of light emitted from the corresponding plurality of emitting ports uniformly differ from each other by a fixed frequency (nHz) in terms of frequency.

Still preferably, the center wavelength of light emitted from the respective emitting ports of the corresponding first arrayed waveguide diffraction grating shifts by (n/2) Hz from the center wavelength of light emitted from the respective emitting ports of the corresponding second arrayed waveguide diffraction grating in terms of frequency.

Preferably, the corresponding first and second optical waveguides are optical fibers.

Still preferably, the corresponding plurality of filters are featured in that the transmission wavelength formed in a transmission band of the corresponding plurality of filters is equal in terms of waveform to the reflection wavelength formed in a reflection band formed by the corresponding plurality of filters.

Preferably, the corresponding plurality of filters is a Bragg grating.

Furthermore, the invention provides an optical demultiplexer module in which one end of a multi-series optical filter having a plurality of reflection type optical filters arrayed in series is connected to an optical circulator, and a wavelength synthesizing and dividing device is connected to the corresponding optical circulator, wherein the reflection wavelength of the respective reflection type filters which constitute the corresponding multi-series optical fiber is substantially coincident with any one of the synthesizing and dividing wavelengths of the corresponding wavelength synthesizing and dividing device, and the corresponding reflection type optical filters are arrayed and disposed in series from a position nearer to the corresponding optical circulator to a position farther therefrom, in a sequence from a reflection type filter corresponding to a wavelength, at which the loss of the synthesizing and dividing wavelength of the corresponding wavelength synthesizing and dividing device, is large to a reflection type filter corresponding to a wavelength, at which the loss of the synthesizing and dividing wavelength is small.

Preferably, the respective reflection type filters constituting the corresponding multi-series optical filter are constructed to be reflection type optical fiber gratings, wherein a wavelength synthesizing and dividing device is connected to the other end of the multi-series optical filter. Also, one or both of a wavelength synthesizing and dividing device connected to an optical circulator and a wavelength synthesizing and dividing device connected to the other end of the multi-series optical filter is (or are) an arrayed waveguide diffraction grating.

The invention also provides an optical demultiplexer module, which is capable of narrowing the interval of wavelengths of divided light.

In addition, according to the invention, since, when combining a multi-series optical filter to which a plurality of reflection type optical filters are connected in series with an arrayed waveguide diffraction grating (wavelength synthesizing and dividing device), the reflection type optical filter corresponding to a wavelength at which the loss of the synthesizing and dividing wavelength of a wavelength synthesizing and dividing device is larger is disposed at a position near to an optical circulator, and a reflection type optical filter corresponding to a wavelength at which the loss of the synthesizing and dividing wavelength of a wavelength synthesizing and dividing device is smaller is disposed at a position farther from the optical circulator, a deviation in the loss of the synthesizing and dividing wavelength between emitting ports of the wavelength synthesizing and dividing device can be counterbalanced by the point in that the loss of the reflecting light is increased, depending on the number of optical filters through which light passes, whereby a module with less deviation in the loss between the emitting ports can be achieved. Since the optical demultiplexer module need not be provided with an attenuator at each of ports, the module size can be reduced, and production cost thereof can be decreased. Also, by reducing the loss at the reflection type filter corresponding to a wavelength at which the loss of the synthesized and divided wavelength of a wavelength synthesizing and dividing device, the total loss of the module can be minimized.

### BRIEF DESCRIPTION OF THE DRAWING

These and other objects and advantages of the present invention will become more apparent and more readily appreciated from the following detailed description of the exemplary embodiments of the invention taken in conjunction with the accompanying drawings, in which:

FIG. 1 is a view for explaining an arrayed waveguide diffraction grating which functions as a wavelength synthesizing and dividing device,

FIG. 2 is a view for explaining and showing the wavelength characteristics of one emitting port of the arrayed waveguide diffraction grating illustrated in FIG. 1,

FIG. 3 is a view for explaining crosstalk of an arrayed waveguide diffraction grating.

FIG. 4A is a spectral characteristic view of a plurality of light synthesized and divided by the first arrayed waveguide diffraction grating, FIG. 4B is a spectral characteristic view of a plurality of light synthesized and divided by the second arrayed waveguide diffraction grating,

FIG. 5 is a general schematic view of an optical demultiplexer module according to a first embodiment of the invention,

FIG. 6 is a wavelength profile view with the abscissa indicating wavelength (frequency) and the ordinate indicating light intensity (absolute value), wherein FIG. 6A is a wavelength profile view of light transmitting through a plurality of filters of the first waveguide and FIG. 6B is a wavelength profile view of reflected light,

FIG. 7 is a waveform view in which the wavelength profile views in FIGS. 6A and 6B are partially enlarged, wherein FIG. 7A is a waveform view of transmitted light and FIG. 7B is a waveform view of reflected light,

FIG. 8A through FIG. 8F are spectral characteristic views showing multiplexed light entering the first arrayed waveguide diffraction grating in FIG. 5, and the spectral characteristics regarding light division,

FIG. 9A through FIG. 9F are spectral characteristic views showing multiplexed light entering the second arrayed waveguide diffraction grating in FIG. 5, and the spectral characteristics regarding light division,

FIG. 10 is a spectral characteristic view collectively showing all emitting light of an optical demultiplexer module according to the first preferred embodiment of the invention,

FIG. 11A, FIG. 11B, and FIG. 11C are general schematic views showing applied examples of an optical demultiplexer module in FIG. 5,

FIG. 12 is a general schematic view of an optical demultiplexer module according to a second preferred embodiment of the invention,

FIG. 13 is a view showing a proposed example of an arrayed waveguide diffraction grating (optical demultiplexer module) pertaining to the invention in order to describe another embodiment thereof,

FIG. 14 is an explanatory view showing reflection characteristics of a multi-series optical filter,

FIG. 15 is an explanatory view showing one example of an optical demultiplexer module in which the number of optical fiber gratings is further increased in comparison to that of the proposed example in FIG. 13,

FIG. 16 is an explanatory view in which the wavelength characteristics of respective channels of the arrayed waveguide diffraction grating illustrated in FIG. 1 overlap,

FIG. 17 is an explanatory showing another preferred embodiment of an optical demultiplexer module according to the invention,

FIG. 18 is a view showing reflection characteristics of a multi-series optical filter used in an optical demultiplexer module in FIG. 17,

FIG. 19 is a view showing and explaining still another preferred embodiment related to an optical demultiplexer module in FIG. 17 according to the invention,

FIG. 20 is a schematic diagram of a drop module; and,

FIG. 21 is a schematic diagram of a network branch with a demultiplexing node according to the invention to compensate for the loss profile of a drop module.

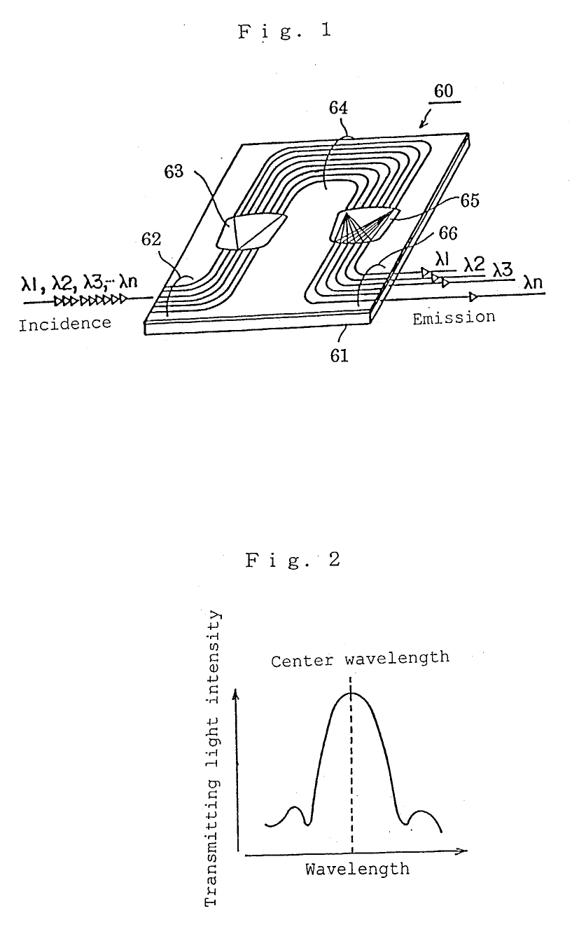

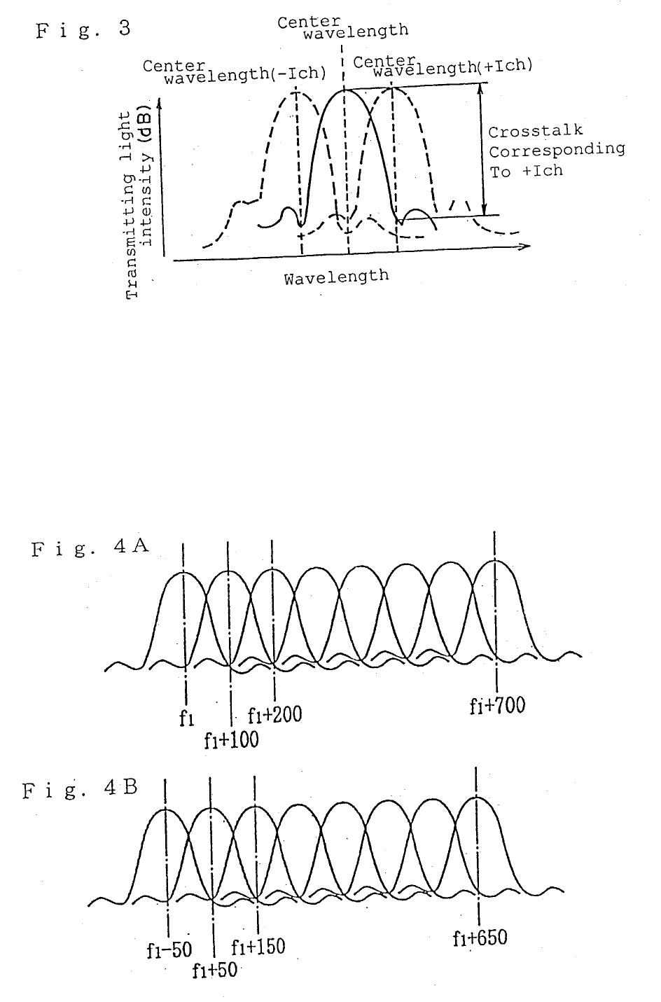

### DETAILED DESCRIPTION OF THE PREFERRED EMBODIMENTS

Hereinafter, a detailed description is given of preferred embodiments of the invention with reference to the accompanying drawings.

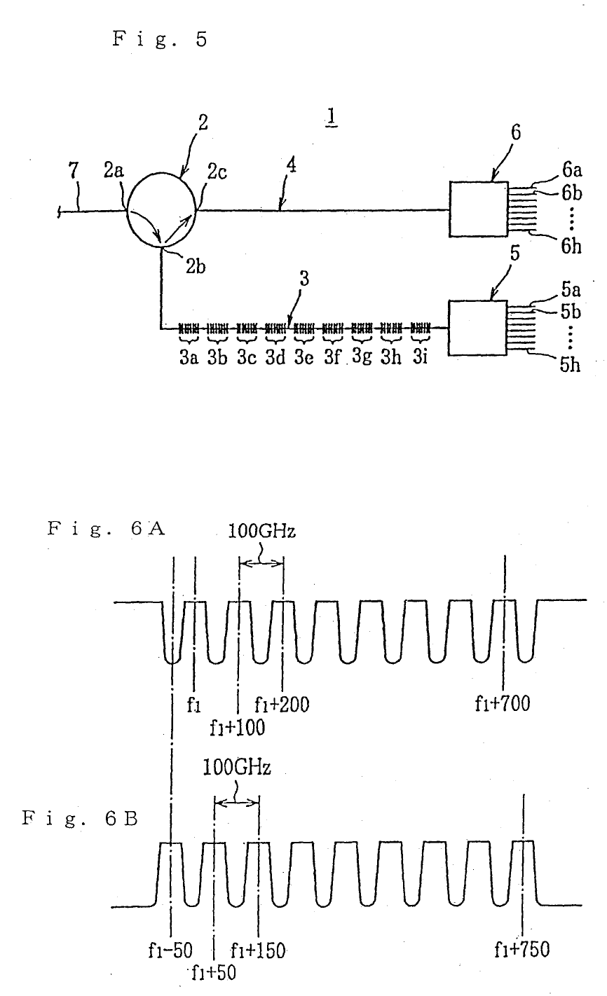

First, an optical demultiplexer module according to the first preferred embodiment of the invention is provided, as shown in FIG. 5, with an optical circulator 2, the first optical fiber 3 being the first optical waveguide, the second optical fiber 4 being the second optical waveguide, the first arrayed waveguide diffraction grating 5 and the second arrayed waveguide diffraction grating 6.

In the optical circulator 2, an incident fiber 7 is connected to an incident port 2a, and the first optical fiber 3 and second optical fiber 4, respectively, connected to the emitting ports 2b and 2c.

The first optical fiber 3 and second optical fiber 4, respectively, have a core and cladding (not illustrated), and the first optical fiber 3 has the first arrayed waveguide diffraction grating 5 connected to one end thereof while the second optical fiber 4 has the second arrayed waveguide diffraction grating 6 connected to one end thereof.

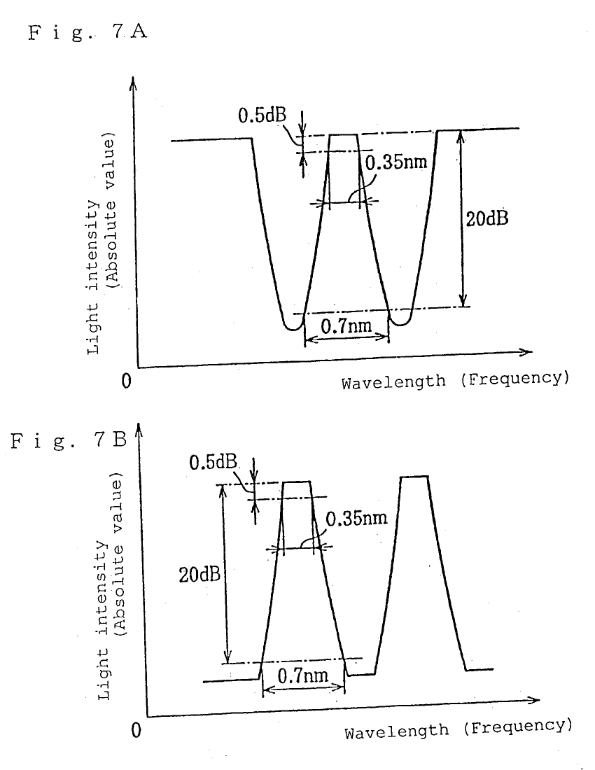

In the first optical fiber 3, nine Bragg gratings 3a through 3i (hereinafter merely called “grating”), which reflect light of predetermined different wavelengths and transmit light other than the above wavelengths are formed on the core. The gratings 3a through 3i reflect light of nine wavelengths at intervals from f1−50 (GHz) through 100 GHz in terms of frequency with respect to the center wavelength of reflecting light. Therefore, the gratings 3a through 3i transmit light of a wavelength profile having nine troughs corresponding to the reflected wavelength as shown in FIG. 6A in which the abscissa indicates wavelength and ordinate indicate light intensity. As shown in FIG. 6B, the gratings 3a through 3i reflect light of a wavelength profile in which the portions corresponding to the nine troughs in FIG. 6A becomes peaks. Herein, in FIGS. 6A and 6B, the abscissa indicates wavelength (frequency), and ordinate indicates light intensity (absolute value). At this time, such gratings 3a through 3i were used, in which, as in the case of the transmitted light shown in FIG. 7A which partially enlarges FIG. 6A and FIG. 6B and in the case of the transmitted light shown in FIG. 7B, the entire width becomes 0.35 nm when the transmitted light and the intensity thereof descends by 0.5 dB, and the entire width becomes 0.7 nm when they descend by 20 dB, and the waveform of transmitted light is equal to that of reflected light. In FIG. 7A and FIG. 7B, it is assumed that the abscissa indicates wavelength (frequency), and the ordinate indicates light intensity (absolute value). Herein, both optical fibers 3 and 4, and incident fibers 7 may be flat optical waveguides.

The first arrayed waveguide diffraction grating 5 and the second arrayed waveguide diffraction grating 6, respectively, have eight emitting ports 5a through 5h, and 6a through 6h.

Herein, the first arrayed waveguide diffraction grating 5 has a spectral characteristic shown in FIG. 4A when a plurality of wavelengths to be multiplexed are multiplexed, and, after dividing light having a plurality of wavelengths, which was transmitted at the gratings 3a through 3i in a state that the interval of the center wavelengths shifts by 100(=n) GHz regulated by the ITU-T (International Telecommunication Union-Telecommunication Standardization Sector), causes the light to enter the respective eight emitting ports 5a through 5h. For example, where it is assumed that the center wavelength of light entering the emitting port 5a is f1 (GHz) in terms of frequency, in the first arrayed waveguide diffraction grating 5, f1+100 (GHz) enters the emitting port 5b, f1+200 (GHz) enters the emitting port 5c, and finally f1+700 (GHz) enters the emitting port 5h. Herein, in FIG. 4A and FIG. 4B, the abscissa indicates wavelength (frequency), and the ordinate indicates light intensity (absolute value).

Where wavelengths of a plurality of light to be divided are multiplexed, the second arrayed waveguide diffraction grating has a spectral characteristic shown in FIG. 4B, and, after dividing light of nine wavelengths at an interval of 100 GHz from f1−50 (GHz), which is reflected by the gratings 3a through 3i and transmitted to the second optical fiber, causes the light to enter the respective eight ports 6a through 6h. Therefore, in the second arrayed waveguide diffraction grating 6, where it is assumed that the center wavelength of light entering the emitting port 6a is f1−50 (GHz) in terms of frequency, f1+50 (GHz) enters the emitting port 6b, f1+150 (GHz) enters the emitting port 6c, and finally f1+650 (GHz) enters the emitting port 6h, all of which shifts by n/2(n=100) GHz from that of the first arrayed waveguide diffraction grating 5. Therefore, in the spectral characteristic illustrated in FIG. 4A and FIG. 4B, the center wavelength of light corresponding to the vertical direction shifts by a wavelength equivalent to 50 (GHz).

Herein, for the purpose of utilizing light of a number of wavelengths, the optical demultiplexer module 1 divides light transmitted through the gratings 3a through 3i by the first arrayed waveguide diffraction grating 5. But, in the case of utilizing only light with a plurality of wavelengths, which is reflected by the gratings 3a through 3i, the first arrayed waveguide diffraction grating 5 is no longer required.

In the optical demultiplexer module 1 constructed as described above, multiplexed light consisting of a number of wavelengths, which entered the optical circulator 2 via the incident fiber 7, is transmitted from the emitting port 2b to the first optical fiber 3.

The multiplexed light consisting of a number of wavelengths, which is transmitted to the first optical fiber 3, is divided into light having a plurality of wavelengths, which propagates through the gratings 3a through 3i and is transmitted to the first arrayed waveguide diffraction grating 5, and light having a plurality of wavelengths, which is reflected by the gratings 3a through 3i and is transmitted from the optical circulator 2 to the second optical fiber 4.

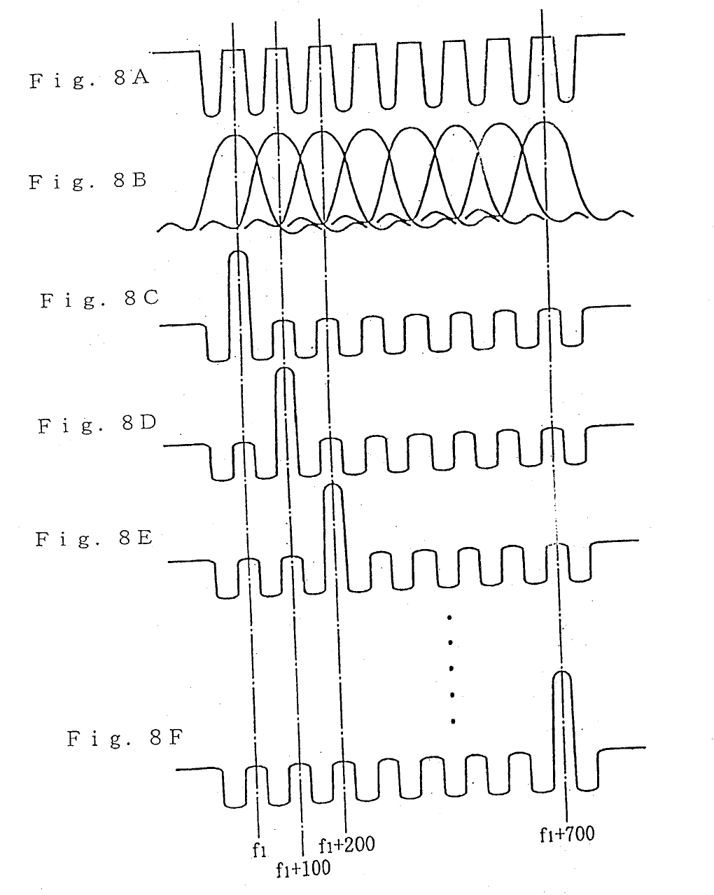

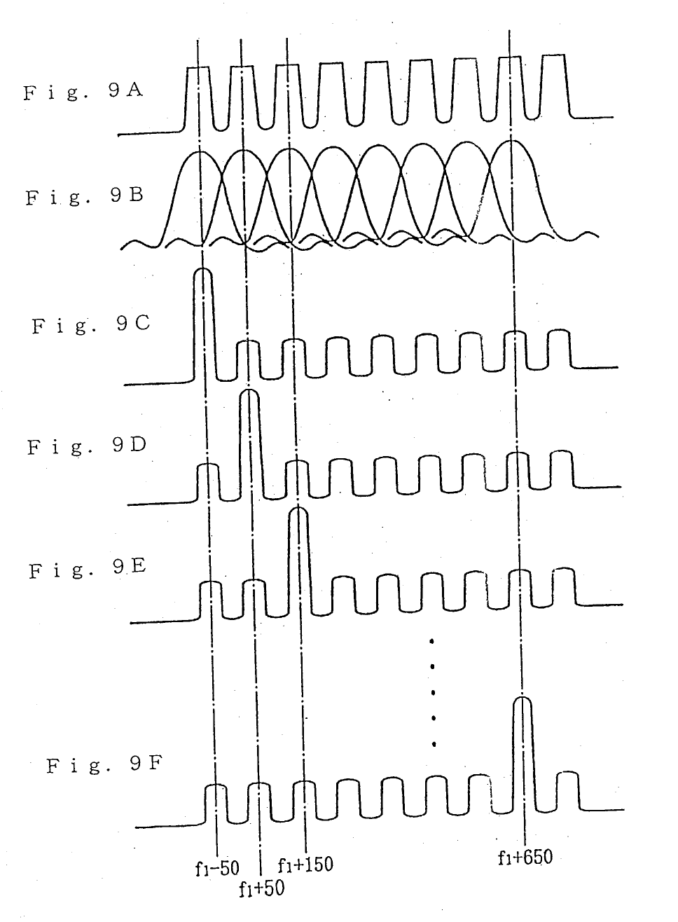

At this time, light having a plurality of wavelengths, which propagates through the gratings 3a through 3i, has a wavelength profile shown in FIG. 8A, and the first arrayed waveguide diffraction grating 5 itself has the inherent spectral characteristics shown in FIG. 8B with respect to the division of light. Therefore, the first arrayed diffraction grating 5 emits light, whose center wavelength is frequency f1 (GHz) shown in FIG. 8C, to the emitting port 5a, frequency f1+100 (GHz) shown in FIG. 8D, to the emitting port 5b, frequency f1+200 (GHz) shown in FIG. 8E, to the emitting port 5c, . . . and finally frequency f1+700 (GHz) shown in FIG. 8E, to the emitting port 5h, in all cases of which both sides of the peak waveform thereof are almost perpendicular. That is, the first waveguide diffraction grating 5 divides the wavelength of light whose waveform is made almost perpendicular in the waveform profile in FIG. 8A, and emits the light.

On the other hand, a plurality of light reflected by the gratings 3a through 3i have a waveform profile having peak waveforms, both sides of which are almost perpendicular as shown in FIG. 9A, and the second arrayed waveguide diffraction grating 6 itself has an inherent spectral characteristic as shown in FIG. 9B with respect to dividing of the light. Therefore, the second waveguide diffraction grating 6 emits light, whose frequency is f1−50 (GHz) as shown in FIG. 9C, to the emitting port 6a, whose frequency is f1+50 (GHz) as shown in FIG. 9D, to the emitting port 6b, whose frequency is f1+150 (GHz) as shown in FIG. 9E, to the emitting port 6c, . . . and finally whose frequency is f1+650 (GHz) as shown in FIG. 9F, to the emitting port 6h, in all cases thereof, the light has an almost perpendicular peak waveform at both sides thereof.

Herein, in FIG. 8A through FIG. 8F and FIG. 9A and FIG. 9B, the abscissas indicate wavelength (frequency), and the ordinates indicate light intensity (absolute value).

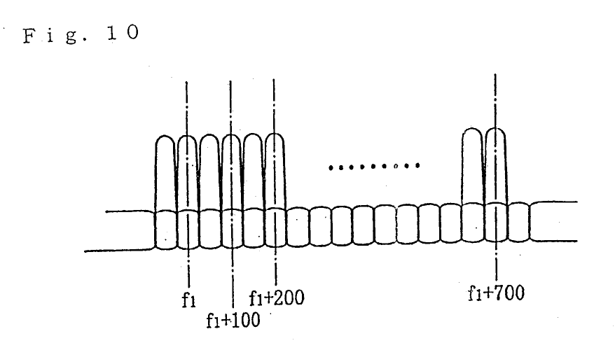

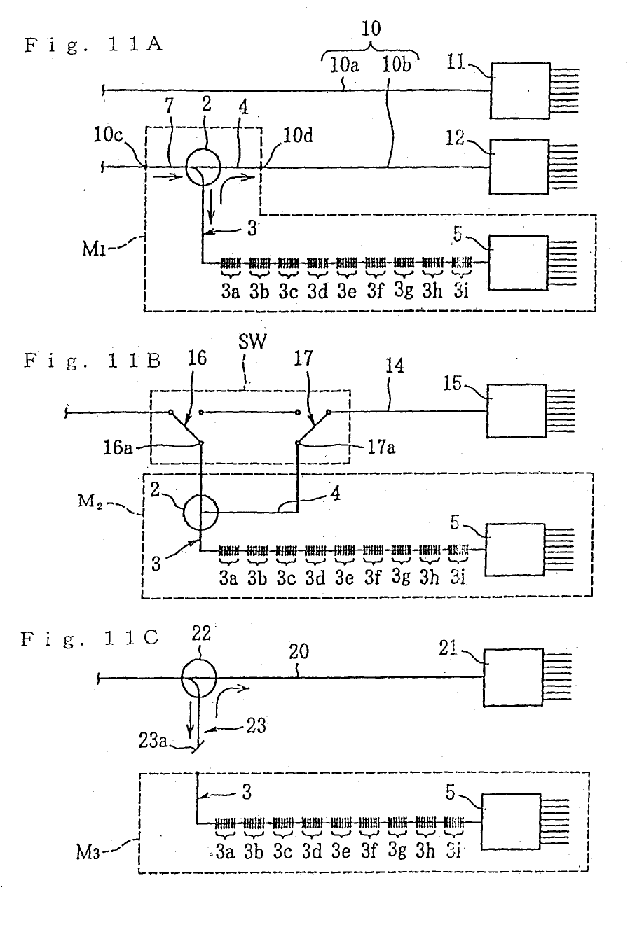

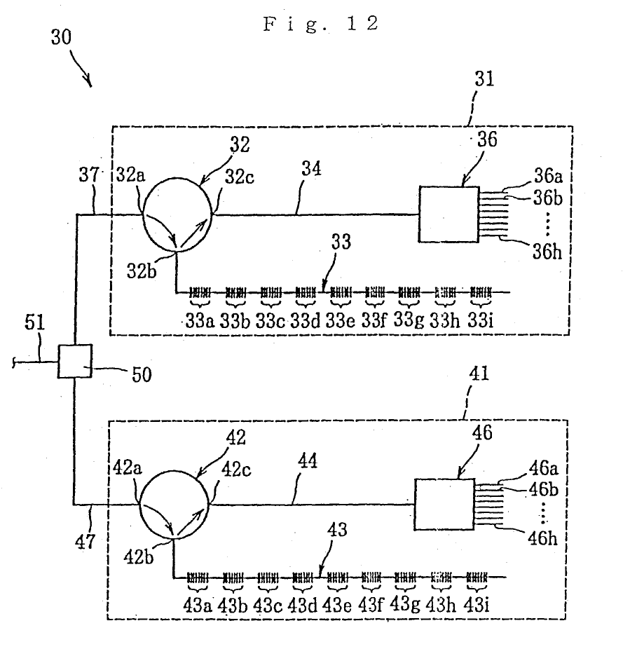

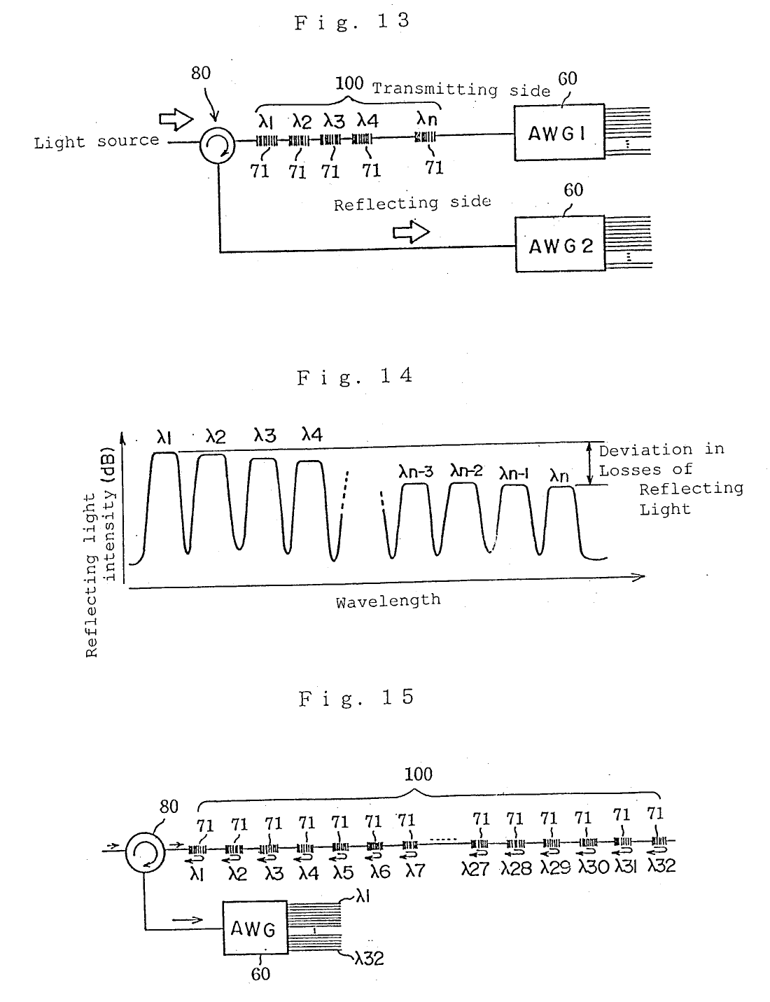

Thus, as shown in FIG. 10, sixteen light beams having an almost perpendicular peak waveform, in which adjacent light beams are independent from each other, are emitted from the eight emitting ports 5a through 5h of the first arrayed waveguide diffraction grating and from the emitting ports 6a through 6h of the second arrayed waveguide diffraction grating, wherein the respective frequencies are f1−50, f1, f1+50, f1+100, f1+150, . . . , f1+650 and f1+700 (GHz).

In other words, the first arrayed waveguide diffraction grating 5 and the second waveguide diffraction grating 6 themselves have a spectral characteristic in which the light beams of the respective wavelengths overlap each other at both sides thereof as shown in FIG. 8B and FIG. 9B. By gratings being disposed at the preceding side of the arrayed waveguide diffraction gratings 5 and 6, it is possible to divide light whose waveform is sharp and is of an almost perpendicular peak as shown in FIG. 10. Herein, in FIG. 10, the abscissa indicate wavelength (frequency), and the ordinate indicates light intensity (absolute value).

As has been made clear in the above description, using the optical demultiplexer module 1, multiplexed light consisting of a plurality of light in which the interval between wavelengths is made narrow can be divided into independent light beams having a sharp peak waveform, whereby it is possible to sufficiently prevent crosstalk in optical frequency-multiplexed transmissions.

Further, when upgrading the existing optical transmission lines, the optical demultiplexer module 1 may be used as shown below:

That is, for example, as shown in FIG. 11A, connecting portions 10c and 10d are prepared in one of optical fibers 10b of optical fibers 10a and 10b of an already laid optical transmission line 10. Herein, arrayed waveguide diffraction gratings (AWG) 11 and 12 are provided at the ends of the optical fibers 10a and 10b. Also, a change module M1 is prepared by removing the second arrayed waveguide diffraction grating 6 shown in FIG. 5 from the second optical fiber 4, and employing a connecting means such as a connector, etc., to be connected to the connecting portions 10c and 10d at the ends of the second optical fiber 4 and incident fiber 7.

If so constructed, the optical transmission line 10 can be upgraded by removing an optical fiber between the connecting portions 10c and 10d and connecting the change module M1 to the part as shown in FIG. 11A as necessary. Therefore, with the optical transmission line 10, by causing light of differing wavelengths in the reverse direction to enter from the respective emitting ports of the first arrayed waveguide diffraction grating 5 and the second arrayed waveguide diffraction grating 6 as necessary, it is possible to obtain multiplexed light consisting of a plurality of wavelengths having sharp and perpendicular peak waveforms, whereby the transmission capacity can be remarkably increased free from crosstalk.

In addition, as shown in, for example, FIG. 11B, a switching portion SW having change switches 16 and 17 may be provided in an optical fiber 14 which constitutes the optical transmission line, and a change module M2 may be connected to connecting portions 16a and 17a. At this time, an arrayed waveguide diffraction grating 15 is provided at the end portion of an optical fiber 14. Also, in the change module M2, the second arrayed waveguide diffraction grating 6 is removed from the second optical fiber 4 of the optical demultiplexer module 1 shown in FIG. 5, and a connecting means such as a connector, etc., to be connected to the change portions 16a and 17a is provided at the end portions of the second optical fiber 4 and the incident fiber 7.

Therefore, the optical fiber 14 constituting an optical transmission line can be upgraded by only connecting a change module M2 to the connecting portions 16a and 17a as in the case of the optical transmission line 10 shown in FIG. 11A, wherein it is possible to obtain multiplexed light consisting of a plurality of wavelengths having sharp and perpendicular peak waveforms, from the first arrayed waveguide diffraction grating 5 and the second waveguide diffraction grating 15. Therefore, the optical fiber 14 which constitutes an optical transmission line can remarkably increase the transmission capacity free from crosstalk by utilizing the change module 14.

Further, as shown in FIG. 11C, a branching fiber 23 having an entire reflection mirror 23a is connected to an optical fiber 20 constituting an optical transmission line via an optical circulator 22. And, a connecting portion (not illustrated) is provided at the end portion of the branching fiber 23 after removing the reflection mirror 23a at the end portion of the branching fiber 23, whereby since a change module M3 can be connected, utilizing the connecting portion, the optical transmission line can be upgraded. Herein, the optical fiber 20 is provided with an arrayed waveguide diffraction grating 21 at the end portion in advance as illustrated. In addition, the change module M3 may be constructed so as to have only the first optical fiber 3 and first arrayed waveguide diffraction grating 5 of the optical demultiplexer module 1, a connecting means such as a connector, etc., to be connected to the abovementioned connecting portion may be provided at the end portion of the first optical fiber 3.

Therefore, the optical fiber 20 which constitutes the optical transmission line can be easily upgraded by only providing a change module M3 at the connecting portion. As in the case of the optical transmission line shown in FIG. 11A, it is possible to obtain multiplexed light consisting of a plurality of wavelengths having sharp and perpendicular waveforms from the first arrayed waveguide diffraction grating 5 and arrayed waveguide diffraction grating 21. Therefore, by only utilizing the change module M3, the transmission capacity can be substantially increased without crosstalk.

Next, a description is given of an optical demultiplexer module 30 according to a second preferred embodiment of the invention with reference to FIG. 12.

In the optical demultiplexer module 30, the first optical transmission processing unit 31 is optically connected to the second optical transmission processing unit 41 via an optical branching device 50.

Herein, the construction of the first optical transmission processing unit 31 is identical to that of the second optical transmission processing unit 41, excepting that the wavelengths reflected by the first optical fibers 33 and 43 described later, which is the first optical waveguide, differ. Therefore, first, the first optical transmission processing unit 31 is described. As regards the second optical transmission processing unit 41, in FIG. 12, parts corresponding to each other are given the corresponding reference numbers, and overlapping description is omitted.

The first optical transmission processing unit 31 is provided with an optical circulator 32, the first optical fiber 33, the second optical fiber 34 being the second optical waveguide, and an arrayed waveguide diffraction grating 36.

In the optical circulator 32, an incident fiber 37 is connected to an incident port 32, and the first optical fiber 33 and second optical fiber 34, respectively, are connected to emitting ports 32b and 32c.

The first optical fiber 33 and the second optical fiber 34 have a core and cladding (not illustrated), and in the second optical fiber 34, an arrayed waveguide diffraction grating 36 is connected to the end portion thereof.

In the first optical fiber 33, nine Bragg gratings (hereinafter merely called “grating”) 33a through 33i, which reflect different wavelengths determined in advance and transmit the other wavelengths are formed on the core. The gratings 33a through 33i light of nine wavelengths at intervals from f1 (GHz) to 100 GHz in terms of frequency to the second optical fiber 34 via the optical circulator 32 with respect to the center wavelengths of reflecting light. In the gratings 33a through 33i, light in which the transmitting waveform of transmitted light is equal to the reflecting waveform of reflected light is used. Also, in the first optical transmission processing unit 31 and the second optical transmission processing unit 41, the first optical fibers 33 and 43 being the first optical waveguides, the second optical fibers 34 and 44 being the second optical waveguides, and incident fibers 37 and 47 may be formed to be a flat waveguide.

The arrayed waveguide diffraction gratings 36, respectively, have eight emitting ports 36a through 36h.

Herein, the arrayed waveguide diffraction grating 36 has a spectral characteristic similar to that of the second arrayed waveguide diffraction grating 6 used in the first preferred embodiment, and the arrayed waveguide diffraction grating 36 divides light into a plurality of wavelengths, which has transmitted the gratings 33a through 33i, in a state where the interval of the center wavelength shifts by 100(=n) GHz, and causes the light to enter the eight emitting ports 36a through 36h. For example, where it is assumed that, in the first arrayed waveguide diffraction grating 36, the center wavelength of light entering the emitting ports 36a is f1 in terms of frequency, light of f1+100 (GHz) is caused to enter the emitting port 36b, light of f1+200 (GHz) is caused to enter the emitting port 36c, . . . and light of f1+700 (GHz) is caused to enter the emitting port 36h.

On the other hand, the arrayed waveguide diffraction grating 46 has a spectral characteristic which is similar to that of the second arrayed waveguide grating 6 used in the first preferred embodiment, wherein the arrayed waveguide diffraction grating 46 divides light into a plurality of wavelengths, which has transmitted the gratings 43a through 43i, in a state where the interval of the center wavelength shifts by 100(=n) GHz, and causes light to enter the eight emitting ports 46a through 46h. For example, where it is assumed that, in the first arrayed waveguide diffraction grating 46, the center wavelength of light entering the emitting ports 46a is f1+50 (GHz) in terms of frequency, light of f1+150 (GHz) is caused to enter the emitting port 46b, light of f1+250 (GHz) is caused to enter the emitting port 46c, . . . and light of f1+750 (GHz) is caused to enter the emitting port 46h.

An input fiber 51 is connected to the incident side of an optical branching device 50, the optical branching device 50 is connected to the first optical transmission processing unit 31 and the second optical transmission processing unit 41 via incident fibers 37 and 47.

In the optical demultiplexer module 30 thus constructed, multiplexed light consisting of a number of wavelengths incident via the input fiber 51 is branched by the optical branching device 50. And, the branched multiplexed light is transmitted to the first optical fibers 33 and 43 after having made incident on the optical circulators 32 and 42.

Multiplexed light consisting of a number of wavelengths transmitted into the first optical fiber 33 is reflected by the gratings 33a through 33i and is transmitted into the second optical fiber 34 through the optical circulator 32, wherein the light transmitted through the gratings 33a through 33i is discharged from the cut-off end as it is.

At this time, multiplexed light of a plurality of wavelengths, which is reflected by the gratings 33a through 33i and is transmitted to the second optical fiber 34, is branched by the arrayed waveguide diffraction grating 36. Also, light whose center wavelength is a frequency f1 (GHz) is caused to enter the emitting port 36a, light whose center wavelength is a frequency f1+100 (GHz) is caused to enter the emitting port 36b, light whose center wavelength is a frequency f1+100 (GHz) is caused to enter the emitting port 36c, . . . and finally light whose center wavelength is a frequency f1+700 (GHz) is caused to enter to the emitting port 36h, wherein, in all the cases, the light has a sharp and perpendicular peak wavelength at both sides thereof and the wavelength interval is made narrow.

On the other hand, multiplexed light consisting of a number of wavelengths, which is transmitted to the first optical fiber 43, is reflected by the gratings 43a through 43i, and is transmitted to the second optical fiber 44. The light propagated through the gratings 43a through 43i is discharged from the cut-off end as it is.

At this time, multiplexed light of a plurality of wavelengths, which is reflected by the grating 43a through 43i and is transmitted to the second optical fiber 44, is branched by the arrayed waveguide diffraction grating 46, wherein light whose center wavelength is a frequency f1+50 (GHz) is caused to enter the emitting port 46a, light whose center wavelength is a frequency f1+150 (GHz) is caused to enter the emitting port 46b, light whose center wavelength is a frequency f1+250 (GHz) is caused to enter the emitting port 46c, . . . and light whose center wavelength is a frequency of f1+750 (GHz) is caused to enter the emitting port 46h, and in all the cases, the waveform of the light is sharp and perpendicular at both sides thereof.

Thus, sixteen light beams, each having a sharp and perpendicular peak waveform, whose wavelength (frequency) is f1 , f+50, f1+100, f1+150, . . . f1+700, f1+750 (GHz) being shifted by 50 GHz, and adjacent wavelengths (frequencies) are independent from each other, are emitted from the eight emitting ports 36a through 36h and another emitting ports 46a through 46h of the arrayed waveguide diffraction gratings 36 and 46.

As has been made clear in the above description, using the optical demultiplexer module 30, multiplexed light consisting of a plurality of light in which the interval between wavelengths is made narrow, can be divided into light beams whose waveform is sharp and perpendicular. And it is possible to sufficiently prevent crosstalk in optical frequency-multiplexed transmissions.

Also, although a description was given of the optical demultiplexer modules 1 and 30 of the abovementioned preferred embodiments, in which an optical circulator is used, it is needless to say that, instead of the optical circulator 2, a non-reciprocal optical branching device, for example, a combination of an arrayed waveguide diffraction grating and an isolator, and an optical coupler, etc., may be used in the optical demultiplexer module 1. In addition, further, the optical demultiplexer modules 1 and 30 according to the abovementioned preferred embodiments are based on an optical circulator and gratings. However, it is also needless to say that components having a synchronous transmission characteristic with respect to wavelengths, for example, a Mach-Zehnder circuit may be used.

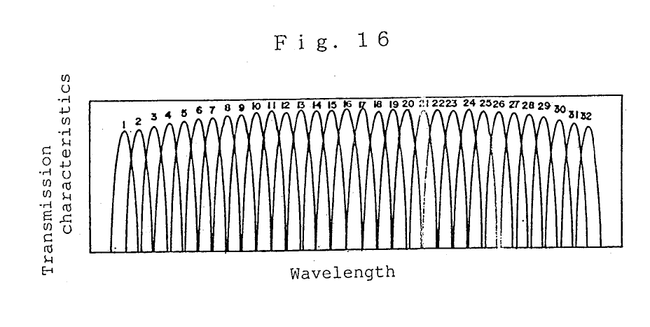

Next, a description is given of still another preferred embodiment of the invention, which can make uniform the dividing light intensity of respective wavelengths divided and outputted from an arrayed waveguide diffraction grating. For the convenience of description, an optical demultiplexer module is proposed, which can function as an optical fiber grating 71 (FBG) as shown in FIG. 13, and a wavelength synthesizing and dividing device. The module is such that the Bragg gratings 3a through 3f shown in FIG. 5 showing the first preferred embodiment, are incorporated in multi-series, and all the others are identical to those shown in FIG. 5.

In the optical demultiplexer module shown in FIG. 13, the interval between channels of the two respective arrayed waveguide diffraction gratings 60 is 100 GHz. However, the gratings are set so that the center wavelength shifts by 50 GHz, whereby it is possible to obtain satisfactory flatness of the reflecting light and transmitting light by combining the gratings with multi-series optical fiber gratings 71. By utilizing high isolation of the wavelength synthesizing and dividing device, an optical demultiplexer module with less crosstalk, in which the interval between wavelengths is 50 GHz, can be obtained while keeping flatness.

In the arrayed waveguide diffraction grating, since it is unavoidable that a minute loss resulting from propagation of light through the optical fiber gratings 71 occurs, the number of optical fiber gratings 71 is further increased at the optical fiber gratings 71 located farther from the incident ports if the light reflected by the optical fiber gratings is used. The loss is accordingly increased. Resultantly, a deviation in loss arises between light reflected by the near optical fiber gratings 71 and light reflected by the far optical fiber gratings 71.

FIG. 14 exemplarily shows reflection characteristics (wavelength dependency) of respective filter portions of a multi-series optical fiber grating 100 constructed as shown in FIG. 13. The reflection characteristics (wavelength dependency) express wavelength dependency in the reflection loss where gratings 71 are sequentially disposed from the position near the optical circulator 80 to the side far therefrom so that the gratings 71 gradually have a longer wavelength in sequence from the shorter wavelength side optical fiber grating 71. In FIG. 14, the longer wavelength side optical fiber gratings 71, that is, the optical fiber gratings located innermost will have a further increased loss, and the same drawing shows a state where a deviation occurs in the reflection characteristics as a whole.

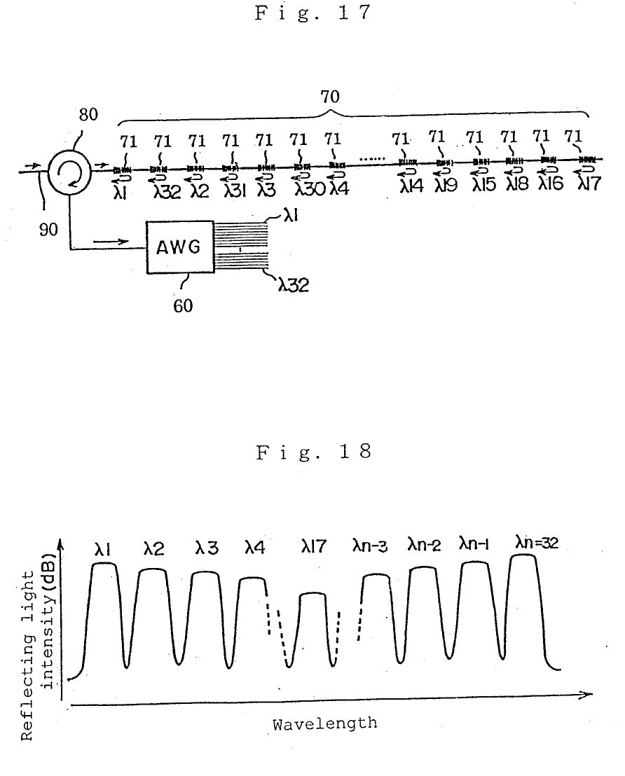

The more the number of optical fiber gratings 71 is increased, the more remarkable the deviation becomes. For example, in a case where the number of optical fiber gratings 71 is, for example, 32 as shown in FIG. 15, a loss deviation of approx. 3.1 dB occurs between a wavelength (λ1) reflected at this side and a wavelength (λ32) reflected innermost where it is assumed that the loss per transmission through the optical grating fibers 71 is approx. 0.05 dB. And, where the multi-series optical fiber grating 100 and an arrayed waveguide diffraction grating 60 are used in combination, the total loss deviation will become 4.6 dB (6.1 dB−1.5 dB) as shown in Table 1 where the deviation in loss between the emitting ports of the arrayed waveguide diffraction grating 60 is 3 dB or so.

TABLE 1
Loss of WDM (wavelength division multiplexing filter)
in which a multi-series FBG
and AWG are combined (Prior art)

| | | Number of | Loss (dB) due | | Total |
|---|---|---|---|---|---|
| Port | Wave- | times of FBG | to FBG | Loss of | loss |
| No. | length | transmissions | transmissions | AWG (dB) | (dB) |
| 1 | λ1 | 0 | 0.0 | 3.0 | 3.0 |
| 2 | λ2 | 2 | 0.1 | 2.8 | 2.9 |
| 3 | λ3 | 4 | 0.2 | 2.6 | 2.8 |
| 4 | λ4 | 6 | 0.3 | 2.4 | 2.7 |
| 5 | λ5 | 8 | 0.4 | 2.2 | 2.6 |
| 6 | λ6 | 10 | 0.5 | 2.0 | 2.5 |
| 7 | λ7 | 12 | 0.6 | 1.8 | 2.4 |
| 8 | λ8 | 14 | 0.7 | 1.6 | 2.3 |
| 9 | λ9 | 16 | 0.8 | 1.4 | 2.2 |
| 10 | λ10 | 18 | 0.9 | 1.2 | 2.1 |
| 11 | λ11 | 20 | 0.1 | 1.0 | 2.0 |
| 12 | λ12 | 22 | 1.1 | 0.8 | 1.9 |
| 13 | λ13 | 24 | 1.2 | 0.6 | 1.8 |
| 14 | λ14 | 26 | 1.3 | 0.4 | 1.7 |
| 15 | λ15 | 28 | 1.4 | 0.2 | 1.6 |
| 16 | λ16 | 30 | 1.5 | 0.0 | 1.5 |
| 17 | λ17 | 32 | 1.6 | 0.0 | 1.6 |
| 18 | λ18 | 34 | 1.7 | 0.2 | 1.9 |
| 19 | λ19 | 36 | 1.8 | 0.4 | 2.2 |
| 20 | λ20 | 38 | 1.9 | 0.6 | 2.5 |
| 21 | λ21 | 40 | 2.0 | 0.8 | 2.8 |
| 22 | λ22 | 42 | 2.1 | 1.0 | 3.1 |
| 23 | λ23 | 44 | 2.2 | 1.2 | 3.4 |
| 24 | λ24 | 46 | 2.3 | 1.4 | 3.7 |
| 25 | λ25 | 48 | 2.4 | 1.6 | 4.0 |
| 26 | λ26 | 50 | 2.5 | 1.8 | 4.3 |
| 27 | λ27 | 52 | 2.6 | 2.0 | 4.6 |
| 28 | λ28 | 54 | 2.7 | 2.2 | 4.9 |
| 29 | λ29 | 56 | 2.8 | 2.4 | 5.2 |
| 30 | λ30 | 58 | 2.9 | 2.6 | 5.5 |
| 31 | λ31 | 60 | 3.0 | 2.8 | 5.8 |
| 32 | λ32 | 62 | 3.1 | 3.0 | 6.1 |

Further, the transmittance at which light transmits through respective emitting ports of the arrayed waveguide diffraction grating 60 is not constant, and has a deviation. This is shown in FIG. 16. FIG. 16 shows the overlapped wavelength characteristics of respective channels of the arrayed waveguide diffraction grating 60 having 32 emitting ports. It is shown that the transmittances of the respective emitting ports differ from each other. Herein, in the respective emitting ports, a difference in the transmittance at the center wavelength results from the characteristics of the arrayed waveguide diffraction grating 60. Generally, there is a tendency in which the transmittance further worsens toward both ends, and the transmittance further becomes satisfactory toward the central part. Where used in wavelength multiplexed transmissions, it is highly recommended that the difference in the transmittance between the emitting ports is reduced.

As shown in FIG. 15, Table 1 expresses the number of times of transmission of optical fiber gratings 71, loss resulting from transmission of the optical fiber gratings 71, loss of the arrayed waveguide diffraction grating 60, and total losses per wavelength where the optical fiber gratings 71 are disposed in the order of shorter wavelength.

Herein, in reality, the loss of the arrayed waveguide diffraction grating 60 never becomes 0 dB even in the vicinity of the center emitting ports. However, in order to easily understand a description of a deviation in loss in respective wavelengths, it is assumed that the loss is zero in the vicinity of the center emitting ports (16th port and 17th port), and the deviation in loss is judged at the respective emitting ports on the basis of the center emitting ports.

In the above example, where there is a connected part (for example, welded part) at which optical fiber gratings 71 are coupled to each other, the deviation will become larger.

As described above, in a dividing device (a composite type wavelength synthesizing and dividing device) which achieves division (synthesization where light advances in the reverse direction of dividing) of wavelengths, whose interval is narrow, by utilizing a wavelength synthesizing and dividing device such as an arrayed waveguide diffraction grating and a reflection type optical filter such as optical fiber gratings, the loss of reflecting light will be increased, depending on the number of optical filters (optical fiber gratings) through which light passes.

Also, since the transmission loss differs by respective emitting ports (wavelengths) in the arrayed waveguide diffraction grating, the transmission loss for the respective wavelengths will greatly differ to produce a large deviation.

Therefore, in a case where the abovementioned construction is used in a real system, it is considered that an attenuator is attached to each of the emitting ports of the arrayed waveguide diffraction grating installed at the opposite side of the optical fiber gratings, thereby lowering the deviation in loss between ports. But in such a case, the module size is increased and attenuators whose quantity is equal to the number of wavelengths are required, whereby production cost of the module is increased. Further, a loss at the optical fiber gratings is added to that of the arrayed waveguide diffraction gratings, and the loss will be increased as a whole.

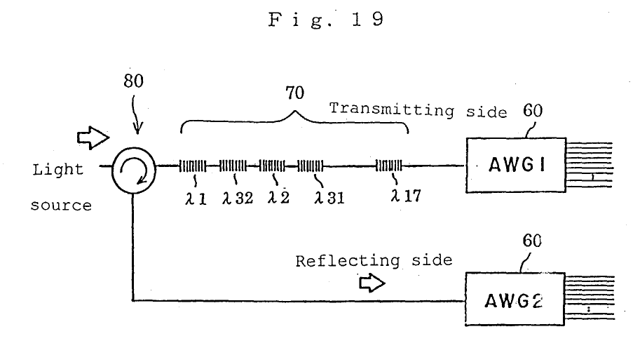

FIG. 17 shows an embodiment capable of avoiding an increase in loss, in which an optical demultiplexer module according to the invention has further been improved. As shown in FIG. 17, the optical demultiplexer module has an arrayed waveguide diffraction grating 60 with thirty-two channels (only some of the channels are illustrated due to the convenience of indication), a multi-series optical filter 70 and an optical circulator 80 as a wavelength synthesizing and dividing device.

The arrayed waveguide diffraction grating 60 is connected to an input optical fiber 90 and a multi-series optical filter 70 via an optical circulator 80. Also, an optical path from the optical circulator 80 to the multi-series optical filter 70 functions as the first optical waveguide, and an optical path from the optical circulator 80 to the arrayed waveguide diffraction grating 60 functions as the second optical waveguide.

The arrayed waveguide diffraction grating 60 divides light into wavelengths from λ1 through λ32 and emits the light from respective emitting ports. However, as shown in FIG. 16, the transmission loss is largest at the emitting port at both extreme ends, that is, the first emitting port (wavelength λ1) and the thirty-second emitting port (wavelength λ32), and the transmission loss is gradually reduced toward the center, wherein the loss is the minimum at the center emitting port, that is, the seventeenth emitting port (wavelength λ17) in the preferred embodiment.

In this preferred embodiment, thirty-two optical fiber gratings are connected in series in the multi-series optical filter 70 as a reflection type optical filter.

The respective optical fiber gratings 71, respectively, reflect wavelengths λ1 through λ32 corresponding to the wavelengths λ1 through λ32 emitted from the respective emitting port of the arrayed waveguide diffraction grating.

Herein, an array of the respective optical fiber gratings 71 constituting the multi-series optical filter 70 is such that an optical fiber grating 71 (wavelength λ1) and an optical fiber grating 71 (wavelength λ32) corresponding to the first emitting port (wavelength λ1) and the thirty-second emitting port (wavelength λ32), which are at both the extreme ends where the transmission loss of the arrayed waveguide diffraction grating 60 is the largest, are located closest to the optical circulator. Subsequently, optical fiber gratings are located in the order of the transmission loss being gradually reduced, that is, an optical fiber grating 71 (wavelength λ2) and an optical fiber grating 71 (wavelength λ31). Finally, the optical fiber grating 71 (wavelength λ17) corresponding to the seventeenth emitting port (wavelength λ17) at which the transmission loss is the minimum, is located farthermost from the optical circulator 80, in other words, is located innermost.

FIG. 18 shows reflection characteristics of the respective optical fiber gratings 71 constituting a multi-series optical fiber 70.

As has been made clear in FIG. 18, in the respective fiber gratings 71, the loss of the reflecting light is increased, depending on the number of optical fiber gratings 71 through which light passes.

That is, the loss of the reflecting light is smaller in the optical fiber grating 71 (wavelength λ1) and optical fiber grating (wavelength λ32), which are disposed closest to the optical circulator 80, and that is largest in the optical fiber grating (wavelength λ17) located farthermost from the optical circulator 80.

As a result, in the optical demultiplexer module shown in FIG. 17, the sum of the loss in transmission of the arrayed waveguide diffraction grating 60 and the loss in reflection depending on the number of the optical fiber gratings is made uniform, the deviation of the losses of the wavelengths (from λ1 through λ32) emitted from the arrayed waveguide diffraction grating 60 can be decreased as shown in Table 2.

Table 2 expresses the values of losses of the arrayed waveguide diffraction grating 60, as in Table 1, where the minimum value is assumed to be zero. According to Table 2, the loss in a combination of the arrayed waveguide diffraction grating 60 and a multi-series optical fiber 70 is 3.0 dB through 3.1 dB, wherein it is found that there is almost no difference in deviation between the emitting ports.

TABLE 2
Loss of WDM (wavelength division multiplexing filter)
in which a multi-series FBG
and AWG are combined (The present invention)

| | | Number of | Loss (dB) due | | Total |
|---|---|---|---|---|---|
| Port | Wave- | times of FBG | to FBG | Loss of | loss |
| No. | length | transmissions | transmissions | AWG (dB) | (dB) |
| 1 | λ1 | 0 | 0.0 | 3.0 | 3.0 |
| 2 | λ2 | 4 | 0.2 | 2.8 | 3.0 |
| 3 | λ3 | 8 | 0.4 | 2.6 | 3.0 |
| 4 | λ4 | 12 | 0.6 | 2.4 | 3.0 |
| 5 | λ5 | 16 | 0.8 | 2.2 | 3.0 |
| 6 | λ6 | 20 | 1.0 | 2.0 | 3.0 |
| 7 | λ7 | 24 | 1.2 | 1.8 | 3.0 |
| 8 | λ8 | 28 | 1.4 | 1.6 | 3.0 |
| 9 | λ9 | 32 | 1.6 | 1.4 | 3.0 |
| 10 | λ10 | 36 | 1.8 | 1.2 | 3.0 |
| 11 | λ11 | 40 | 2.0 | 1.0 | 3.0 |
| 12 | λ12 | 44 | 2.2 | 0.8 | 3.0 |
| 13 | λ13 | 48 | 2.4 | 0.6 | 3.0 |
| 14 | λ14 | 52 | 2.6 | 0.4 | 3.0 |
| 15 | λ15 | 56 | 2.8 | 0.2 | 3.0 |
| 16 | λ16 | 60 | 3.0 | 0.0 | 3.0 |
| 17 | λ17 | 62 | 3.1 | 0.0 | 3.1 |
| 18 | λ18 | 58 | 2.9 | 0.2 | 3.1 |
| 19 | λ19 | 54 | 2.7 | 0.4 | 3.1 |
| 20 | λ20 | 50 | 2.5 | 0.6 | 3.1 |
| 21 | λ21 | 46 | 2.3 | 0.8 | 3.1 |
| 22 | λ22 | 42 | 2.1 | 1.0 | 3.1 |
| 23 | λ23 | 38 | 1.9 | 1.2 | 3.1 |
| 24 | λ24 | 34 | 1.7 | 1.4 | 3.1 |
| 25 | λ25 | 30 | 1.5 | 1.6 | 3.1 |
| 26 | λ26 | 26 | 1.3 | 1.8 | 3.1 |
| 27 | λ27 | 22 | 1.1 | 2.0 | 3.1 |
| 28 | λ28 | 18 | 0.9 | 2.2 | 3.1 |
| 29 | λ29 | 14 | 0.7 | 2.4 | 3.1 |
| 30 | λ30 | 10 | 0.5 | 2.6 | 3.1 |
| 31 | λ31 | 6 | 0.3 | 2.8 | 3.1 |
| 32 | λ32 | 2 | 0.1 | 3.0 | 3.1 |

Further, the array sequence of the optical fiber gratings is not limited to an example of the embodiment in FIG. 17. Any array, which is capable of reducing the inherent deviation in losses, may be acceptable.

Also, by measuring the values of losses of the respective emitting ports of the arrayed waveguide diffraction grating 60 in advance, the order of the optical fiber gratings 71 may be adjusted and optimized. In a case where there is a connecting loss between optical fiber gratings, the connecting loss may be adjusted and optimized.

Still further, as shown in the abovementioned preferred embodiments, an optical demultiplexer module according to the invention is capable of not only reducing an increase in the deviation of losses due to integration by combining an arrayed waveguide diffraction grating with a multi-series optical fiber but also reducing the deviation in losses between the emitting ports, which the arrayed waveguide diffraction grating inherently has.

Still further, it is needless to say that a module, in which a wavelength synthesizing and dividing device such as an arrayed waveguide diffraction grating 60, etc., is connected to the transmitting side (transmission outputting side) of the multi-series optical fiber 70 as shown in FIG. 19, may be applicable as an optical demultiplexer module according to the invention.

Also, although, in the preferred embodiments, optical fiber gratings 71 are connected in series in each of the reflecting wavelengths to make a multi-series optical fiber 70, a plurality of optical fiber gratings 71 having reflecting wavelengths differing in the lengthwise direction of an optical fiber are formed by being exposed one after another to light, whereby a multi-series optical filter 70 free from any connecting portion or having less connecting ports may be constructed. By eliminating the connecting portions or reducing the number thereof, it is possible to reduce the losses of light transmitting through the optical fiber gratings 71.

In addition, instead of an optical circulator 80, it is needless to say that a non-reciprocal optical branching device may be used in the circuit of FIG. 17.

Although the device according to the invention uses the same components as the device according to Pan, the prior art device according to Pan makes no reference to the order of the Bragg gratings. Thus, a demultiplexer according to Pan is likely to have an optical response similar to that described in Table 1.

As previously described, the invention teaches that by properly ordering the Bragg gratings by wavelength, the output wavelength profile of the optical circuit is flattened. In order to achieve a similar result using commercially available products absent the teaching of the invention it is necessary to incorporate at least one additional component. The obvious choice for providing a flat wavelength profile is a gain flattening filter. The gain flattening filter is expensive and more importantly, it has fixed behavior. Consequently, the filter must be matched to the other optical components in order to ensure the best output wavelength profile. A filter of this type will flatten the wavelength response of most optical circuits however the filter will introduce more insertion loss to the system. Typically, these filters are incorporated with erbium doped fiber amplifiers that have differing gains for signals at different wavelengths. The invention clearly demonstrates that a proper order of the components allows the wavelength profile to be flattened without incurring excessive insertion loss.

The insertion loss and the wavelength dependence of insertion loss of arrayed waveguide gratings have been discussed. Other optical components demonstrate this type of behavior also. For example, in long distance transmission networking applications, it is known that optical fiber has some wavelength dependence. Additionally, it has been shown that by ordering optical components different wavelength dependant insertion loss characteristics are produced. Thus, in many optical systems it is common that optical signals having different wavelengths originally provided at a same intensity are likely to have different intensities elsewhere in the optical network.

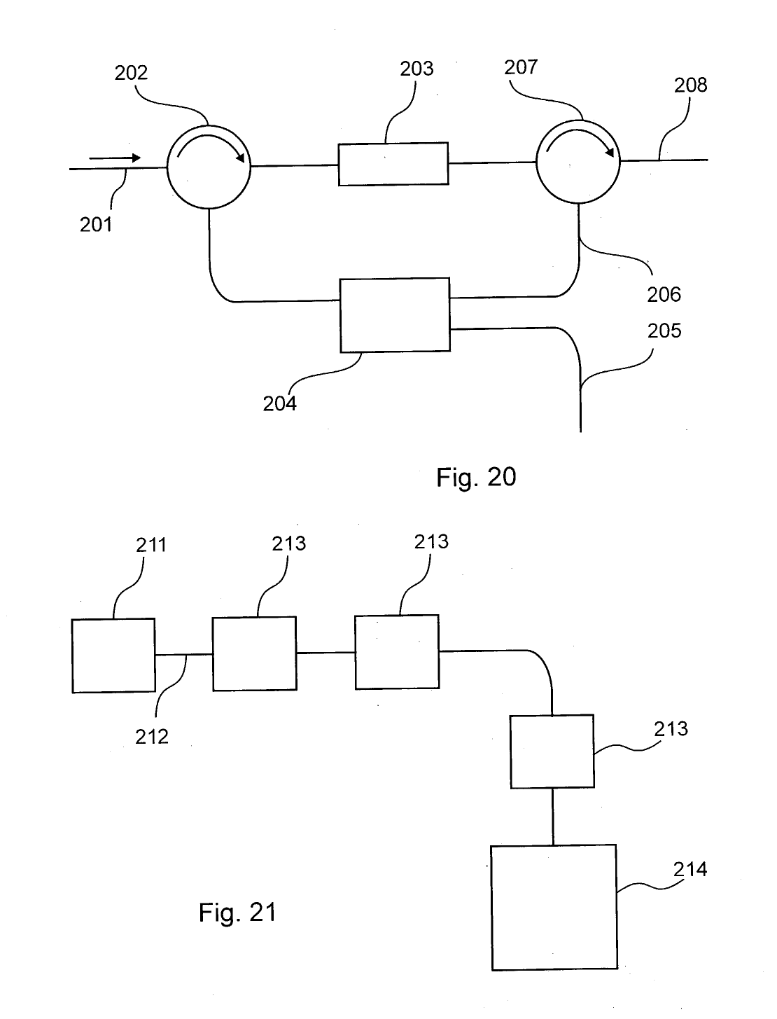

Referring to FIG. 20, a drop module is described. A wavelength multiplexed optical signal propagates along the input fiber 201. The signal propagates through the circulator 202. The signal then propagates to the fiber Bragg grating 203. The Bragg grating 203 selectively reflects optical signals as described hereinbefore. Reflected optical signals propagate back to the circulator 202 and then to the switch 204. If the switch is configured to drop the signals then the signals will propagate to the output fiber 205. Alternatively, the signals are not dropped and are provided to fiber 206. These optical signals propagate to the second circulator 207. From the second circulator the reflected optical signals propagate back to the Bragg grating 203 where they are reflected again. These optical signals propagate to the second circulator again where they are directed to the output optical fiber 208. Those optical signals that were not reflected by the Bragg grating 203 propagate though it. They then are directed to the output fiber 208. Clearly, those optical signals that propagate through the optical switch 204 experience more attenuation than those that do not. The insertion loss for a small mechanical optical switch consistent with this application is likely to be substantially 0.3 dB.

Referring to FIG. 21, a branch of a long haul network is shown. A wavelength multiplexed optical signal is provided by a source 211. These signals propagate along the waveguide 212 and are optionally dropped at the drop module 213. The drop module 213 is consistent with the drop module described in FIG. 20. In this example, the optical signals have wavelength given by λ1 to λ16. The optical signals corresponding to wavelengths λ1 and λ2 are for being dropped and various locations along the network. Thus, the Bragg grating 203 of FIG. 20 is designed to reflect light having a wavelength corresponding to λ1 and λ2, while allowing other optical signals to propagate without reflecting. The optical signals propagate to a demultiplexer 204 separates the each of the optical signals in dependence upon wavelength. The demultiplexer 204 is designed to compensate for the additional attenuation experienced by the optical signals at wavelengths λ1 and λ2 as well as the attenuation profile of the components of the demultiplexer itself. Thus, the demultiplexer 204 is designed to receive wavelength multiplexed optical signals having an other than uniform intensity profile and provide optical signals with a significantly more uniform loss profile. Clearly, in many cases this method will be unable to provide an absolutely flat attenuation profile however, the profile of the output signals is improved without adding additional components or incurring additional expense. In this way, the multiplexer/demultiplexer module according to the invention acts as a gain flattening filter.

Clearly, numerous other embodiment of the invention may be envisioned without departing from the spirit or the scope of the invention.

What is claimed is:

1. An optical demultiplexer module comprising:
an optical element comprising at least one of a circulator and a non-reciprocal optical branching device;
a first and a second optical waveguides connected to said optical element; and,
a second arrayed waveguide diffraction grating connected to said second optical waveguide, the second arrayed waveguide having a plurality of emitting ports, wherein
said first optical waveguide has a plurality of filters for reflecting light of specified wavelengths to said second optical waveguide via said optical element,
said second arrayed waveguide diffraction grating is constructed so that center wavelengths of light emitted from said plurality of emitting ports differ from each other by a certain predetermined frequency in terms of frequency, and
said plurality of optical filters are ordered, such that in use, the optical demultiplexer module provides a substantially equal amount of attenuation to light of the specified wavelengths propagating between the optical element for coupling to said first waveguide and said plurality of emitting ports.

2. An optical demultiplexer module as set forth in claim 1, wherein the second arrayed waveguide diffraction grating comprises at least one port where the center wavelength of light reflected from said plurality of filters at the first optical waveguide side matches one to one the center wavelength of light emitted from said plurality of emitting ports of said arrayed waveguide diffraction grating.

3. An optical demultiplexer module as set forth in claim 1, wherein, in the second arrayed waveguide diffraction grating, the center wavelengths of light emitted from a plurality of emitting ports uniformly differ from each other by a fixed frequency (nHz) in terms of frequency.

4. An optical demultiplexer module as set forth in claim 1, wherein a first arrayed waveguide diffraction grating is connected to the first optical waveguide, said first arrayed waveguide diffraction grating has a plurality of emitting ports, in which the center wavelengths of light emitted from said plurality of emitting ports differ from each other by a certain frequency predetermined in terms of frequency.

5. An optical demultiplexer module as set forth in claim 4, wherein the first arrayed waveguide diffraction grating has at least one port where the center wavelength of light transmitting through a plurality of filters which said first optical waveguide has matches one to one the center wavelength of light emitted from said plurality of emitting ports.

6. An optical demultiplexer module as set forth in claim 4, wherein, in the first arrayed waveguide diffraction grating, the center wavelengths of light emitted from a plurality of emitting ports uniformly differ from each other by a fixed frequency (nHz) in terms of frequency.

7. An optical demultiplexer module as set forth in claim 3, wherein the center wavelength of light emitted from the uniformly differing emitting ports of said first arrayed waveguide diffraction grating shifts by (n/2) Hz from the center wavelength of light emitted from the uniformly differing emitting ports of said second arrayed waveguide diffraction grating in terms of frequency.

8. An optical demultiplexer module as set forth in claim 1, wherein said first and second optical waveguides are optical fibers.

9. An optical demultiplexer module as set forth in claim 1, wherein the transmitting wavelength formed in a transmission band of said plurality of filters is equal in terms of waveform to the reflecting wavelength formed in a reflection band in said plurality of filters.

10. An optical demultiplexer module as set forth in claim 4, wherein the transmitting wavelength formed in a transmission band of said plurality of filters is equal in terms of waveform to the reflecting wavelength formed in a reflection band in said plurality of filters.

11. An optical demultiplexer module as set forth in claim 1, wherein a plurality of filters is a Bragg grating.

12. An optical demultiplexer module as set forth in claim 4, wherein a plurality of filters is a Bragg grating.

13. An optical demultiplexer module comprising:
an optical element comprising at least one of a circulator or a non-reciprocal optical branching device,
a first and a second optical waveguides connected to said optical element; and,
a second arrayed waveguide diffraction grating connected to said second optical waveguide and having a plurality of emitting ports, wherein
said first optical waveguide has a plurality of filters for reflecting light of specified wavelengths to said second optical waveguide via said optical element,
said second arrayed waveguide diffraction grating is constructed so that center wavelengths of light emitted from said plurality of emitting ports differ from each other by a certain predetermined frequency in terms of frequency, and
said plurality of optical filters are ordered, such that in use, the optical demultiplexer module receives a wavelength multiplexed optical signal having a predetermined non-uniform intensity profile, said module provides wavelength dependant attenuation to said wavelength multiplexed optical signal such that a uniformity of the intensity profile of the optical signal is substantially improved.

14. An optical demultiplexer module as set forth in claim 13, wherein the second arrayed waveguide diffraction grating comprises at least one port where the center wavelengths of light reflected from said plurality of filters at the first optical waveguide side matches one to one the center wavelength of light emitted from said plurality of emitting ports of said arrayed waveguide diffraction grating.

15. An optical demultiplexer module as set forth in claim 13, wherein, in the second arrayed waveguide diffraction grating, the center wavelengths of light emitted from a plurality of emitting ports uniformly differ from each other by a fixed frequency (nHz) in terms of frequency.

16. An optical demultiplexer module as set forth in claim 13, wherein a first arrayed waveguide diffraction grating is connected to the first optical waveguide, said first arrayed waveguide diffraction grating has a plurality of emitting ports, in which the center wavelengths of light emitted from said plurality of emitting ports differ from each other by a certain frequency predetermined in terms of frequency.

17. An optical demultiplexer module as set forth in claim 16, wherein the first arrayed waveguide diffraction grating has at least one port where the center wavelength of light transmitting through a plurality of filters which said first optical waveguide has matches one to one the center wavelengths of light emitted from said plurality of emitting ports.

18. An optical demultiplexer module as set forth in claim 16, wherein, in the first arrayed waveguide diffraction grating, the center wavelengths of light emitted from a plurality of emitting ports uniformly differ from each other by a fixed frequency (nHz) in terms of frequency.

19. An optical demultiplexer module as set forth in claim 15, wherein the center wavelengths of light emitted from the uniformly differing emitting ports of said first arrayed waveguide diffraction grating shifts by (n/2) Hz from the center wavelengths of light emitted from the uniformly differing emitting ports of said second arrayed waveguide diffraction grating in terms of frequency.

20. An optical demultiplexer module as set forth in claim 13, wherein said first and second optical waveguides are optical fibers.

21. An optical demultiplexer module as set forth in claim 13, wherein the transmitting wavelength formed in a transmission band of said plurality of filters is equal in terms of waveform to the reflecting wavelength formed in a reflection band in said plurality of filters.

22. An optical demultiplexer module as set forth in claim 16, wherein the transmitting wavelength formed in a transmission band of said plurality of filters is equal in terms of waveform to the reflecting wavelength formed in a reflection band in said plurality of filters.

23. An optical demultiplexer module as set forth in claim 13, wherein a plurality of filters is a Bragg grating.

24. An optical demultiplexer module as set forth in claim 16, wherein a plurality of filters is a Bragg grating.
